(19) United States
(12) Patent Application Publication
(10) Pub. No.: US 2026/0202571 A1
(43) Pub. Date: Jul. 16, 2026

(54) USE OF MACHINE LEARNING TECHNIQUES TO ENHANCE AND ACCELERATE INVERSION METHODS FOR THE INTERPRETATION OF DEEP DIRECTIONAL RESISTIVITY MEASUREMENTS

(71) Applicant: SCHLUMBERGER TECHNOLOGY CORPORATION, Sugarland, TX (US)

(72) Inventors: Lin LIANG, Cambridge, MA (US); Michael THIEL, Watertown, MA (US); Dzevat OMERAGIC, Lexington, MA (US); Tianyu WANG, Durham, NC (US)

(21) Appl. No.: 19/134,715

(22) PCT Filed: Dec. 5, 2023
(86) PCT No.: PCT/US2023/082408

§ 371 Date: May 31, 2025

Related U.S. Application Data
(60) Provisional application No. 63/386,264, filed on Dec. 6, 2022.

(51) Int. Cl. G01V 3/38; E21B 44/00; G01V 3/18

(52) U.S. Cl. CPC G01V 3/38; E21B 44/00; G01V 3/18; E21B 2200/22

(57) ABSTRACT

Systems and methods of the present disclosure include acquiring, via a resistivity logging tool of a wellsite system, deep directional resistivity measurement data relating to a subterranean formation, and processing, via a logging and control system, the deep directional resistivity measurement data using inversion algorithms to determine one or more properties of the subterranean formation, wherein processing the deep directional resistivity measurement data using the inversion algorithms includes utilizing machine learning algorithms.

### CROSS-REFERENCE TO RELATED APPLICATION

This application claims priority to and the benefit of U.S. Provisional Patent Application No. 63/386,264, entitled “USE OF MACHINE LEARNING TECHNIQUES TO ENHANCE AND ACCELERATE INVERSION METHODS FOR THE INTERPRETATION OF DEEP DIRECTIONAL RESISTIVITY MEASUREMENTS,” filed Dec. 6, 2022, which is hereby incorporated by reference in its entirety for all purposes.

### FIELD OF THE INVENTION

The present disclosure relates to well logging in oil and gas fields, well placement, and reservoir characterization and, more specifically, to utilizing machine learning methods to accelerate and enhance inversion methods to estimate reservoir resistivity distribution around a wellbore for deep directional resistivity/electromagnetic (EM) data.

### BACKGROUND INFORMATION

Logging tools have long been used in boreholes to make formation evaluation measurements to infer properties of a formation surrounding a borehole and properties of fluids in the formation. Common logging tools include resistivity (electromagnetic) tools, nuclear tools, acoustic tools, and nuclear magnetic resonance (NMR) tools, though various other types of tools for evaluating formation properties are also available.

Early logging tools were run into a borehole on a wireline cable after the borehole had been drilled. Modern versions of such wireline tools are still used extensively. However, as the demand for information while drilling a borehole has continued to increase, measurement-while-drilling (MWD) tools and logging-while-drilling (LWD) tools have since been developed. MWD tools often provide drilling parameter information such as weight on the bit, torque, temperature, pressure, direction, and inclination. LWD tools often provide formation evaluation measurements such as resistivity, porosity, NMR, and so forth. MWD and LWD tools often have characteristics common to wireline tools (e.g., transmitting and receiving antennas, sensors, etc.), however MWD and LWD tools are designed and constructed to operate and endure in the harsh environment of drilling.

Deep directional electromagnetic LWD technology is an enabler of proactive well placement, relying on directional sensitivity measurements and real-time interpretation based on 1D multi-layer model-based inversion, integrated with geological modeling software. New generation of deep directional resistivity tools with reservoir scale measurements enable detection of boundaries and contacts up to 100 feet away from a wellbore, which enables reservoir imaging and optimization of well placement. Hundreds of wells have been drilled using this new technology, some of them in complex geological scenarios, where 1D assumption about the model may not provide enough information and may affect the quality of real-time interpretation.

### SUMMARY

A summary of certain embodiments described herein is set forth below. It should be understood that these aspects are presented merely to provide the reader with a brief summary of these certain embodiments and that these aspects are not intended to limit the scope of this disclosure.

Certain embodiments of the present disclosure include a method that includes acquiring, via a resistivity logging tool of a wellsite system, deep directional resistivity measurement data relating to a subterranean formation. In addition, the method includes processing, via a logging and control system, the deep directional resistivity measurement data using inversion algorithms to determine one or more properties of the subterranean formation. Processing the deep directional resistivity measurement data using the inversion algorithms includes utilizing machine learning algorithms.

### BRIEF DESCRIPTION OF THE DRAWINGS

Various aspects of this disclosure may be better understood upon reading the following detailed description and upon reference to the drawings, in which:

FIG. 1 illustrates an example wellsite system, in accordance with embodiments of the present disclosure;

FIG. 2 illustrates a well control system configured to control the wellsite system of FIG. 1, in accordance with embodiments of the present disclosure;

FIG. 3 is a reservoir map derived from one-dimensional (1D) imaging inversions for a synthetic formation using only data from one receiver and a learned model to estimate λ in an inversion algorithm, in accordance with embodiments of the present disclosure;

FIG. 4 is a reservoir map derived from 1D imaging inversions for the synthetic formation always using data from only one receiver and a brute force method to estimate λ in the inversion algorithm, in accordance with embodiments of the present disclosure;

FIG. 5 is a reservoir map derived from 1D imaging inversions for the synthetic formation using only data from two receivers and a learned model to estimate λ in the inversion algorithm, in accordance with embodiments of the present disclosure;

FIG. 6 is a reservoir map derived from 1D imaging inversions for the synthetic formation always using data from two receivers and a brute force method to estimate λ in the inversion algorithm, in accordance with embodiments of the present disclosure;

FIG. 7 includes a reservoir map derived from 24 1D imaging inversions for five layers on the synthetic formation traversed by a deep directional resistivity tool with one receiver, using a NN instead of the forward modeling and, for comparison, the same inversions repeated with a true forward modeling, with the best (minimum error term) solutions of 20 initial guesses plotted and the achieved error term compared, in accordance with embodiments of the present disclosure;

FIG. 8 includes a reservoir map derived from the same 1D imaging inversions as FIG. 7, but showing the averaged solution instead of the best solution, where the found resistivity profile is compared to the true resistivity profile, in accordance with embodiments of the present disclosure;

FIG. 9 is a reservoir map generated with the trained NN on a formation traversed by a deep directional resistivity tool with two receivers, in accordance with embodiments of the present disclosure;

FIG. 10 is a reservoir map derived from regular 1D imaging inversion on the formation traversed by a deep directional resistivity tool with two receivers, in accordance with embodiments of the present disclosure;

FIG. 11 illustrates six randomly generated 2D formation realizations, mapped on a non-uniform 32×32 pixel grid, in accordance with embodiments of the present disclosure;

FIG. 12 illustrates a NN architecture for the 2D inversion of one receiver data, in accordance with embodiments of the present disclosure;

FIG. 13 illustrates a sample formation for deep directional resistivity measurement generation, in accordance with embodiments of the present disclosure;

FIG. 14 illustrates the standard inversion result of a deep directional resistivity tool with one receiver traversing the formation of FIG. 13, in accordance with embodiments of the present disclosure;

FIG. 15 illustrates a NN inversion result of a deep directional resistivity tool with one receiver traversing the formation of FIG. 13, in accordance with embodiments of the present disclosure;

FIG. 16 illustrates an inversion result of a deep directional resistivity tool with two receivers traversing the formation of FIG. 13, using the inversion results of FIG. 15 as an initial guess, in accordance with embodiments of the present disclosure;

FIG. 17 illustrates an inversion result of a deep directional resistivity tool with two receivers traversing the formation of FIG. 13, using the inversion results of FIG. 14 as an initial guess, in accordance with embodiments of the present disclosure;

FIG. 18 is a comparison of the inversion mismatch and inverted alignment angle for the inversion result of FIGS. 16 and 17, in accordance with embodiments of the present disclosure; and

FIG. 19 is a flow diagram of a method of utilizing machine learning algorithms as part of inversion algorithms used to process deep directional resistivity measurement data, in accordance with embodiments of the present disclosure.

### DETAILED DESCRIPTION

In the following, reference is made to embodiments of the disclosure. It should be understood, however, that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the claims except where explicitly recited in a claim. Likewise, reference to “the disclosure” shall not be construed as a generalization of inventive subject matter disclosed herein and should not be considered to be an element or limitation of the claims except where explicitly recited in a claim.

Although the terms first, second, third, etc., may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first”, “second” and other numerical terms, when used herein, do not imply a sequence or order unless clearly indicated by the context. Thus, a first element, component, region, layer or section discussed herein could be termed a second element, component, region, layer or section without departing from the teachings of the example embodiments.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

When an element or layer is referred to as being “on,” “engaged to,” “connected to,” or “coupled to” another element or layer, it may be directly on, engaged, connected, coupled to the other element or layer, or interleaving elements or layers may be present. In contrast, when an element is referred to as being “directly on,” “directly engaged to,” “directly connected to,” or “directly coupled to” another element or layer, there may be no interleaving elements or layers present. Other words used to describe the relationship between elements should be interpreted in a like fashion. As used herein, the term “and/or” includes any and all combinations of one or more of the associated listed terms.

Some embodiments will now be described with reference to the figures. Like elements in the various figures will be referenced with like numbers for consistency. In the following description, numerous details are set forth to provide an understanding of various embodiments and/or features. It will be understood, however, by those skilled in the art, that some embodiments may be practiced without many of these details, and that numerous variations or modifications from the described embodiments are possible. As used herein, the terms “above” and “below”, “up” and “down”, “upper” and “lower”, “upwardly” and “downwardly”, and other like terms indicating relative positions above or below a given point are used in this description to more clearly describe certain embodiments.

In addition, as used herein, the terms “real time”, “real-time”, or “substantially real time” may be used interchangeably and are intended to describe operations (e.g., computing operations) that are performed without any human-perceivable interruption between operations. For example, as used herein, data relating to the systems described herein may be collected, transmitted, and/or used in control computations in “substantially real time” such that data readings, data transfers, and/or data processing steps occur once every second, once every 0.1 second, once every 0.01 second, or even more frequent, during operations of the systems (e.g., while the systems are operating). In addition, as used herein, the terms “continuous”, “continuously”, or “continually” are intended to describe operations that are performed without any significant interruption. For example, as used herein, control commands may be transmitted to certain equipment every five minutes, every minute, every 30 seconds, every 15 seconds, every 10 seconds, every 5 seconds, or even more often, such that operating parameters of the equipment may be adjusted without any significant interruption to the closed-loop control of the equipment. In addition, as used herein, the terms “automatic”, “automated”, “autonomous”, and so forth, are intended to describe operations that are performed are caused to be performed, for example, by a computing system (i.e., solely by the computing system, without human intervention). Indeed, it will be appreciated that the data processing system described herein may be configured to perform any and all of the data processing functions described herein automatically.

In addition, as used herein, the term “substantially similar” may be used to describe values that are different by only a relatively small degree relative to each other. For example, two values that are substantially similar may be values that are within 10% of each other, within 5% of each other, within 3% of each other, within 2% of each other, within 1% of each other, or even within a smaller threshold range, such as within 0.5% of each other or within 0.1% of each other.

Similarly, as used herein, the term “substantially parallel” may be used to define downhole tools, formation layers, and so forth, that have longitudinal axes that are parallel with each other, only deviating from true parallel by a few degrees of each other. For example, a downhole tool that is substantially parallel with a formation layer may be a downhole tool that traverses the formation layer parallel to a boundary of the formation layer, only deviating from true parallel relative to the boundary of the formation layer by less than 5 degrees, less than 3 degrees, less than 2 degrees, less than 1 degree, or even less.

The processing of the measured subsurface parameters may be done through a process known as an inversion technique (usually referred to as an “inversion”). In general, inversion processing includes making an initial estimate or model of the geometry and properties of the earth formations surrounding the well logging instrument. The initial model parameters may be derived in various ways. An expected logging instrument response is calculated based on the initial model. The calculated response is then compared with the measured response of the logging instrument. Differences between the calculated response and the measured response are used to adjust the parameters of the initial model, and the adjusted model is used to again calculate an expected response of the well logging instrument. The expected response for the adjusted model is compared with the measured instrument response, and any difference between them is used to again adjust the model. This process is generally repeated until the differences between the expected response and the measured response fall below a pre-selected threshold.

The reservoir scale deep directional resistivity reservoir mapping-while-drilling technology is routinely used to map boundaries and fluid contacts for geosteering and reservoir characterization. Current interpretation is based on inversion algorithms that require numerous simulations of the tool response until a reservoir map is found that matches the downhole measurements. In general, real-time delivery may only be achieved through performing the inversion in parallel on a computational cluster, even for simple one-dimensional (1D) models. However, it has been found that machine learning may significantly reduce the number of required tool response simulations: For example, neural networks may be trained to take over computationally costly portions of the inversion algorithms or may be trained to directly invert the measurements. Multiple machine learning approaches are described in greater detail herein, using 1D and two-dimensional (2D) inversion of deep directional resistivity measurements as an example.

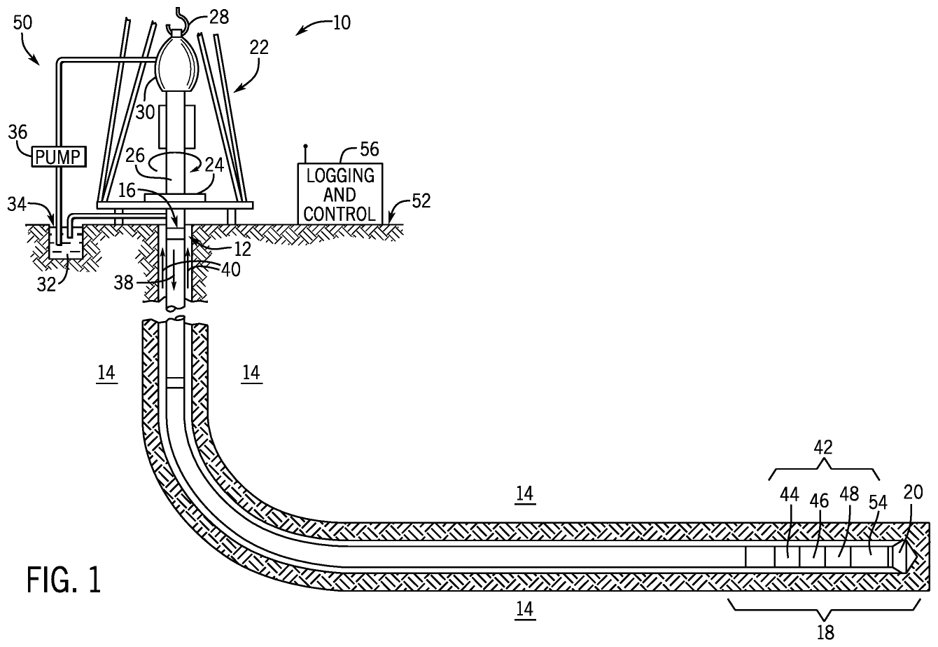

FIG. 1 illustrates a wellsite system 10 within which the embodiments described herein may be employed. The wellsite system 10 may be an onshore wellsite or offshore wellsite. In the illustrated embodiment, the wellsite system 10 is located at an onshore wellsite. In the illustrated embodiment, a borehole 12 is formed in a subterranean formation 14 by rotary drilling in a manner that is well known. The embodiments described herein may be employed in association with other wellsite systems to perform directional drilling.

The wellsite system 10 includes a drill string 16 that may be suspended within borehole 12. The drill string 16 includes a bottom-hole assembly (BHA) 18 with a drill bit 20 at its lower end. In certain embodiments, the wellsite system 10 may include a platform and derrick assembly 22 positioned over the borehole 12. In certain embodiments, the platform and derrick assembly 22 may include a rotary table 24, a kelly 26, a hook 28, and a rotary swivel 30. The drill string 16 may be rotated by the rotary table 24, energized by means not shown, which engages the kelly 26 at an upper end of drill string 16. In certain embodiments, the drill string 16 may be suspended from the hook 28, attached to a traveling block (also not shown), through the kelly 26 and a rotary swivel 30, which may permit rotation of the drill string 16 relative to the hook 28. In certain embodiments, a top drive system may also be used.

In the illustrated embodiment, drilling fluid 32 is stored in a pit 34 formed at the wellsite. In certain embodiments, a pump 36 may deliver the drilling fluid 32 to an interior of the drill string 16 via a port in the swivel 30, causing the drilling fluid 32 to flow downwardly through the drill string 16 as indicated by directional arrow 38. The drilling fluid 32 may then exit the drill string 16 via ports in the drill bit 20, and circulate upwardly through an annulus region between the outside of the drill string 16 and a wall of the borehole 12, as indicated by directional arrows 40. In this manner, the drilling fluid 32 may lubricate the drill bit 20 and carry formation cuttings up to the surface as the drilling fluid 32 is returned to the pit 34 for recirculation.

As illustrated in FIG. 1, in certain embodiments, the BHA 18 may include the drill bit 20 as well as a variety of downhole equipment 42, including a logging-while-drilling (LWD) module 44, a measuring-while-drilling (MWD) module 46, a roto-steerable system and motor, and so forth. In certain embodiments, more than one LWD module 44 and/or MWD module 46 may be employed (e.g., as represented at position 48). References throughout to a module at position 44 may also mean a module at position 48 as well.

For example, in certain embodiments, an LWD module 44 may be housed in a special type of drill collar, as is known in the art, and may include one or more of a plurality of known types of logging tools (e.g., an electromagnetic logging tool, a nuclear magnetic resonance (NMR) tool, and/or a sonic logging tool). In certain embodiments, the LWD module 44 may include capabilities for measuring, processing, and storing information, as well as for communicating with surface equipment 50 (e.g., including all of the equipment above the surface 52 of the wellsite illustrated in and described with reference to FIG. 1). In particular, as described in greater detail herein, the LWD module 44 may include a resistivity logging tool configured to obtain deep directional resistivity measurements that may be used by inversion algorithms to infer geometry and properties of the earth formation surrounding the well logging instrument.

In certain embodiments, an MWD module 46 may also be housed in a special type of drill collar, as is known in the art, and may include one or more devices for measuring characteristics of the well environment, such as characteristics of the drill string 16 and the drill bit 20, for example. In certain embodiments, the MWD module 46 may further include an apparatus (not shown) for generating electrical power to the downhole system, which may include a mud turbine generator powered by the flow of the drilling fluid 32. However, other power and/or battery systems may be employed. In certain embodiments, the MWD module 46 may include one or more of a variety of measuring devices known in the art (e.g., a weight-on-bit measuring device, a torque measuring device, a vibration measuring device, a shock measuring device, a stick slip measuring device, a direction measuring device, an inclination measuring device, and so forth).

In certain embodiments, MWD tools in the MWD module 46, and LWD tools in the LWD module 44 may include one or more characteristics common to wireline tools (e.g., transmitting and receiving antennas, sensors, etc.) with the MWD and LWD tools being designed and constructed to endure and operate in the harsh environment of drilling.

Various systems and methods may be used to transmit information (data and/or commands) from the downhole equipment 42 to the surface 52 of the wellsite. In certain embodiments, information may be received by one or more downhole sensors 54, which may be located in a variety of locations and may be chosen from any sensing and/or detecting technologies known in the art, including those capable of measuring various types of radiation, electric or magnetic fields, including electrodes (such as stakes), magnetometers, coils, and so forth.

In certain embodiments, information from the downhole equipment 42, including LWD data and/or MWD data, may be utilized for a variety of purposes including steering the drill bit 20 and any tools associated therewith, characterizing the formation 14 surrounding borehole 12, characterizing fluids within borehole 12, and so forth. For example, in certain embodiments, information from the downhole equipment 42 may be used to create one or more sub-images of various portions of borehole 12, as described in greater detail herein.

As described in greater detail herein, in certain embodiments, the logging and control system 56 may receive and process a variety of information from a variety of sources, including the downhole equipment 42 and the surface equipment 50. In addition, in certain embodiments, the logging and control system 56 may also control a variety of equipment, such as the downhole equipment 42 and the drill bit 20, as well as the surface equipment 50.

In certain embodiments, the logging and control system 56 may also be used with a wide variety of oilfield applications, including logging while drilling, artificial lift, measuring while drilling, wireline, and so forth, and may include one or more processor-based computing systems, such as a microprocessor, programmable logic devices (PLDs), field-gate programmable arrays (FPGAs), application-specific integrated circuits (ASICs), system-on-a-chip processors (SoCs), or any other suitable integrated circuit capable of executing encoded instructions stored, for example, on tangible computer-readable media (e.g., read-only memory, random access memory, a hard drive, optical disk, flash memory, etc.). Such instructions may correspond to, for example, workflows for carrying out a drilling operation, algorithms and routines for processing data received at the surface 52 from the downhole equipment 42, the surface equipment 50, and so forth.

The logging and control system 56 may be located at the surface 52, below the surface 52, proximate to the borehole 12, remote from the borehole 12, or any combination thereof. For example, in certain embodiments, information received by the downhole equipment 42 and/or the downhole sensors 54 may be processed by the logging and control system 56 at one or more locations, including any configuration known in the art, such as in one or more handheld computing devices proximate or remote from the wellsite system 10, at a computer located at a remote command center, a computer located at the wellsite system 10, and so forth.

In certain embodiments, the logging and control system 56 may be used to create images of the borehole 12 and/or the formation 14 from information received from the downhole equipment 42 and/or from various other tools, including wireline tools. In addition, in certain embodiments, the logging and control system 56 may also perform various aspects of the inversion methods described herein to perform an inversion to obtain one or more desired formation parameters. In addition, in certain embodiments, the logging and control system 56 may also use information obtained from the inversion to perform a variety of operations including, for example, steering the drill bit 20 through the formation 14, with or without the help of a user (e.g., either instructed or autonomous).

FIG. 1 shows an example of the wellsite system 10. However, the embodiments described herein are not necessarily limited to drilling systems. For example, various embodiments described herein may be implemented with wireline systems.

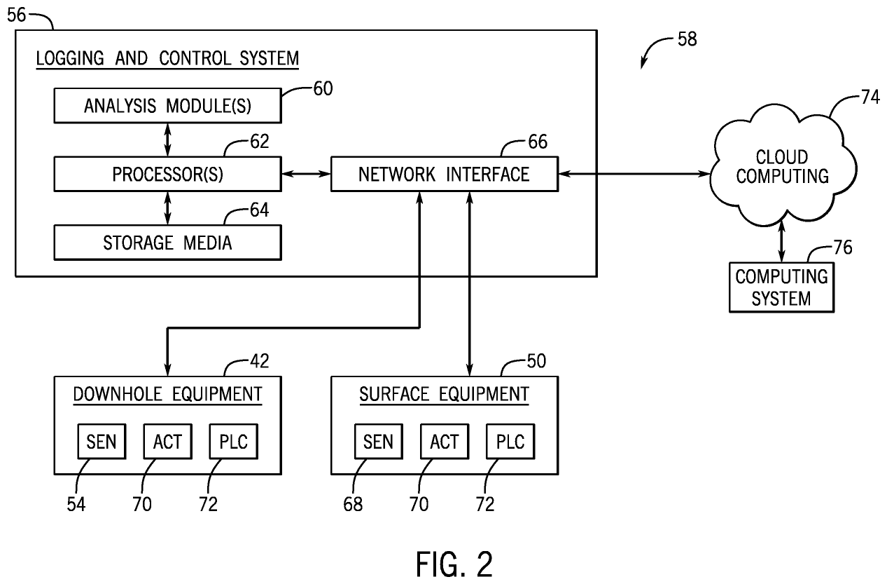

FIG. 2 illustrates a well control system 58 (e.g., that includes the logging and control system 56) configured to control the wellsite system 10 of FIG. 1. In certain embodiments, the logging and control system 56 may include one or more analysis modules 60 (e.g., a program of computer-executable instructions and associated data) that may be configured to perform various functions of the embodiments described herein. In certain embodiments, to perform these various functions, the one or more analysis modules 60 may execute on one or more processors 62 of the logging and control system 56, which may be connected to one or more storage media 64 of the logging and control system 56. Indeed, in certain embodiments, the one or more analysis modules 60 may be stored in the one or more storage media 64.

In certain embodiments, the computer-executable instructions of the one or more analysis modules 60, when executed by the one or more processors 62, may cause the one or more processors 62 to generate one or more models (e.g., forward model, inverse model, mechanical model, and so forth). Such models may be used by the logging and control system 56 to predict values of operational parameters that may or may not be measured (e.g., using gauges, sensors) during well operations.

In certain embodiments, the one or more processors 62 may include a microprocessor, a microcontroller, a processor module or subsystem, a programmable integrated circuit, a programmable gate array, a digital signal processor (DSP), or another control or computing device. In certain embodiments, the one or more processors 62 may include machine learning and/or artificial intelligence (AI) based processors. In certain embodiments, the one or more storage media 64 may be implemented as one or more non-transitory computer-readable or machine-readable storage media. In certain embodiments, the one or more storage media 64 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the computer-executable instructions and associated data of the analysis module(s) 60 may be provided on one computer-readable or machine-readable storage medium of the storage media 64, or alternatively, may be provided on multiple computer-readable or machine-readable storage media distributed in a large system having possibly plural nodes. Such computer-readable or machine-readable storage medium or media are considered to be part of an article (or article of manufacture), which may refer to any manufactured single component or multiple components. In certain embodiments, the one or more storage media 64 may be located either in the machine running the machine-readable instructions, or may be located at a remote site from which machine-readable instructions may be downloaded over a network for execution.

In certain embodiments, the processor(s) 62 may be connected to a network interface 66 of the logging and control system 56 to allow the logging and control system 56 to communicate with the multiple downhole sensors 54 and surface sensors 68, as well as communicate with actuators 70 and/or PLCs 72 of the surface equipment 50 and of the downhole equipment 42 of the BHA 18, as described in greater detail herein. In certain embodiments, the network interface 66 may also facilitate the logging and control system 56 to communicate data to cloud storage 74 (or other wired and/or wireless communication network) to, for example, archive the data or to enable external computing systems 76 to access the data and/or to remotely interact with the logging and control system 56.

It should be appreciated that the well control system 58 illustrated in FIG. 2 is only one example of a well control system, and that the well control system 58 may have more or fewer components than shown, may combine additional components not depicted in the embodiment of FIG. 2, and/or the well control system 58 may have a different configuration or arrangement of the components depicted in FIG. 2. In addition, the various components illustrated in FIG. 2 may be implemented in hardware, software, or a combination of both hardware and software, including one or more signal processing and/or application specific integrated circuits. Furthermore, the operations of the well control system 58 as described herein may be implemented by running one or more functional modules in an information processing apparatus such as application specific chips, such as application-specific integrated circuits (ASICs), field-programmable gate arrays (FPGAs), programmable logic devices (PLDs), systems on a chip (SOCs), or other appropriate devices. These modules, combinations of these modules, and/or their combination with hardware are all included within the scope of the embodiments described herein.

As described in greater detail herein, the analysis modules 60 of the logging and control system 56 may be configured to utilize machine learning methods to accelerate and enhance inversion methods to estimate reservoir resistivity distribution around a wellbore for deep directional resistivity/electromagnetic (EM) data. Examples of the functionality performed by the analysis modules 60 of the logging and control system 56 will be described in further detail below.

### Review of Inversion Process and Machine Learning Application

Usually, only a forward modeling solver is available that may simulate the measurement response f(x) of a deep directional resistivity tool for a given resistivity distribution x around the wellbore. For the inverse process (i.e., finding the resistivity distribution around the wellbore x that leads to a given tool response m), a cost function needs to be defined and minimized:

$$C ( x ) = \frac{1}{2} {‖ {W}_{d} \cdot ( f ( x ) - m ) ‖}^{2} + \frac{1}{2} λ \cdot {ϕ}_{G} ( {W}_{x} \cdot x ) , \qquad ( 1 )$$

where W_{d} is a data weighting matrix applied to the difference between the simulated tool response f for the model defined by the vector x and the actual measurements m. The vector x describes the resistivity distribution (also called formation model) around the wellbore. The model may be defined in numerous ways. For example, in imaging approaches, the model consists of the horizontal and vertical resistivity of fine layers (paired with a 1D EM solver), pixels (paired a 2D EM solver) or voxels (paired with a three-dimensional (3D) EM solver). In addition, the model may represent a specific scenario (e.g., for example a layered formation 14 with a fault on the side in 2D) in which case all model parameters are inverted (e.g., horizontal and vertical resistivity plus layer boundaries and fault position).

Either way, it is important to augment the data error term

$$\frac{1}{2} {‖ {W}_{d} \cdot ( f ( x ) - m ) ‖}^{2}$$

with a regularization term on the model x to prevent artifacts in the estimated model x and to arrive at a realistic resistivity distribution around the wellbore. There are numerous regularization realizations that serve this purpose. One possible regularization is a weighted bi-diagonal matrix Wₓ extracting the gradient in resistivity and resistivity anisotropy (i.e., differences of the layer/pixel/voxel resistivity and resistivity anisotropies in all dimensions). In this example, a function φ_{G}(y)=Σᵢ _{G}(yᵢ) on the first differences, where yᵢ are the elements of the input vector y and

$${φ}_{G} ( {y}_{i} ) = \sqrt{{y}_{i}^{2} + {c}^{2}} ,$$

achieves a l1-norm like regularization for imaging approaches (e.g., using a constant c<<yᵢ). This facilitates the reconstruction of blocky models.

Since the tool responses f(x) simulated by EM solvers are highly non-linear functions, minimization of the cost function C(x) requires a significant amount of forward model calls f(x). There are multiple approaches to carry out the minimization, either stochastically or deterministically. Without loss of generality, the deterministic Gauss-Newton approach is used as an example in the following: C(x) is minimized in an iterative manner. The tool responses are linearized around a starting model x₀,

$$f ( {x}_{0} + Δ x ) \approx f ( {x}_{0} ) + J \cdot Δ x , \qquad ( 2 )$$

where the Jacobian matrix J contains the first derivatives (e.g., sensitivities) of the simulated responses with respect to model parameters x, computed with finite differences or using the adjoint variable technique. The linearized EM solver may be inserted into the cost function from which a model update Δx may then be found, leading to a new model x₀+Δx whose tool response is closer to the measured tool response m. This process may be iteratively repeated until convergence.

The regularization constant A is a relatively important parameter, balancing the data misfit and the regularization terms of the cost function, and ensuring finding the model with the least variation that explains the measurements. For the most accurate inversion results, I cannot be predefined and needs to be estimated in each inversion iteration (e.g., via Occam's method). This requires additional forward model calls.

Use of regularization still doesn't prevent the iterative minimization of C(x) from getting stuck in a false solution (i.e., local minimum). In order to consistently arrive at the true solution for all possible scenarios, multiple inversions may be run with different starting models x₀. In addition, the relatively complex layout of deep directional resistivity tools sometimes requires a multi-step inversion workflow (e.g., usually inverting first only shallow measurements, then reinverting with added deeper measurements) so all resistivity details around the wellbore can be imaged.

As described in greater detail herein, machine learning may be incorporated into the inversion in different ways:
(1) A machine learning algorithm may be trained to estimate the regularization constant λ, eliminating the need for additional forward model calls in the Occam estimation algorithm.
(2) A machine learning algorithm may be trained to learn the forward modeling f(x). The forward modeling is generally the most time-consuming portion of the inversion process, and replacing it with a deep neural network may significantly speed up the inversion. The inversion algorithm itself minimizing C(x) remains unchanged.
(3) A neural network may be trained to directly learn the inverse mapping f⁻¹ from tool response m to the resistivity distribution x. The complete minimization process of C(x) is then replaced with a simple neural network call. The NN may either replace one step of the multi-step inversion workflow or the complete workflow.

All three approaches may be applied to 1D, 2D or 3D inversions and both imaging inversion methods and model-specific inversion methods.

### (1) Machine Learning to Estimate the Regularization Constant

Instead of a search for the regularization constant λ, which requires relatively costly forward model calls, machine learning and data analytics techniques may be used to guide the parameter searching procedure.

### Method for 1D Imaging Inversion

For 1D inversion, the search for A may be carried out brute-force over the entire regularization parameter range. This approach is relatively costly. However, because many inversions have already been run in the past, an enormous amount of data of the following form may exist: the inverted 1D formation model (e.g., resistivities and anisotropy across layers plus dip), and the corresponding best regularization parameters for each inversion iteration.

### Preprocessing and Feature Engineering

Deep directional resistivity measurements sometimes use one receiver or two receivers (e.g., usually twice as far from the transmitter as the first receiver). Those two cases may first be separated, and the dataset may be divided into two disjoint subsets: one for one receiver's data and the other for two receivers' data. Then, the following features may be extracted from the collected inversion results:
Mean/median/standard deviation of resistivity/anisotropy across all layers
Mean/median/standard deviation of resistivity/anisotropy around the tool (i.e., center two pixels)
Mean of difference across adjacent layers in resistivity/anisotropy
Dip
The best regularization parameter 2 of previous inversion iteration
∥ W_{d}·(f(x)−m)∥² of the previous inversion iteration
Current iteration number

### Model and Results

The machine learning model employed may include gradient boosted regression trees, which iteratively fit simple regression trees to the previous residuals and add the simple regression tree to the total ensemble of models.

On a collection of both field and noisy synthetic data, an accurate prediction of 1 may be achieved: For one receiver, the estimated 2 is within the range 0.75·λₜᵣᵤₑ<λₑₛₜ<1.3·λₜᵣᵤₑ 69% of the time and within the range 0.5·λₜᵣᵤₑ<λₑₛₜ<2.0·λₜᵣᵤₑ 91% of the time. The numbers improve for two receivers, the estimated 2 is within the range 0.75·λₜᵣᵤₑ<λₑₛₜ<1.3·λₜᵣᵤₑ 99% of the time and within the range 0.5·λₜᵣᵤₑ<λₑₛₜ<2.0·λₜᵣᵤₑ 97% of the time. These results indicate that, most of the time, the prediction is close to the ground truth. In terms of mean squared error (of the regularization parameter in natural log scale), 6·10⁻⁴ may be achieved for the one receiver case, and 3·10⁻⁶ may be achieved for the two receiver case.

### INCORPORATION INTO INVERSION

If the brute force search for A inside the inversion algorithm is replaced with the learned gradient boosted regression tree for all iterations, inversion results are noticeably degraded and show more artifacts. This is caused by the first inversion iteration, where the learned model to estimate λ performs relatively worse. However, this first iteration is critical in the inversion process, and determines if an inversion gets stuck in a local minimum or finds the true solution. Hence, if the brute force search is kept for the first iteration only, inversions using the learned model after the first iteration perform as well as an inversion that always uses the brute force search.

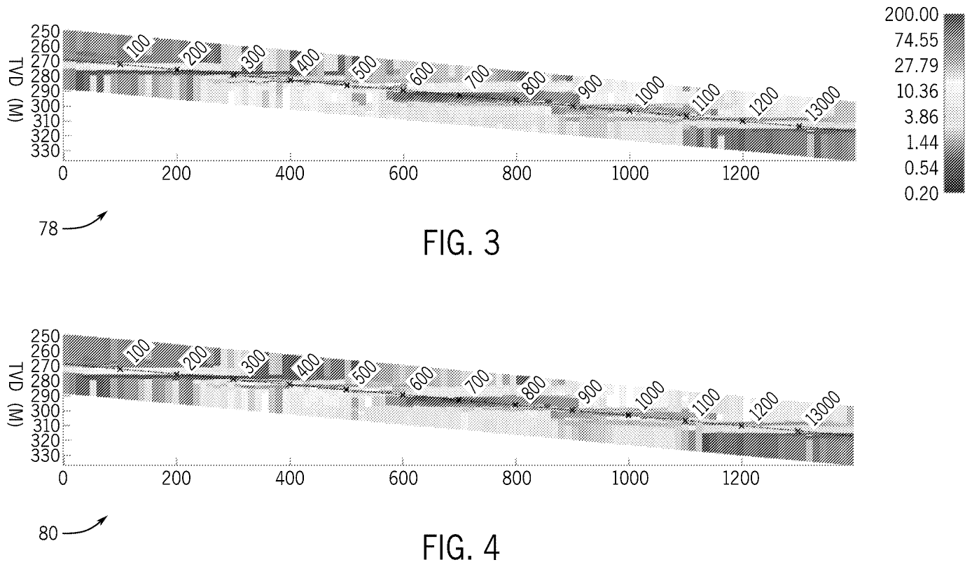

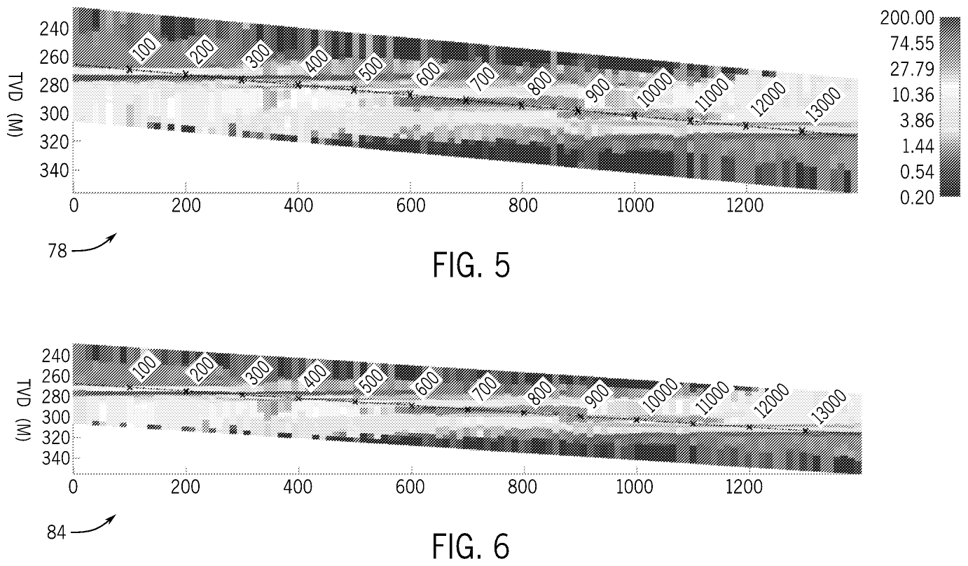

FIG. 3 is a reservoir map 78 derived from one-dimensional (1D) imaging inversions for a synthetic formation using only data from one receiver and a learned model to estimate λ in an inversion algorithm, FIG. 4 is a reservoir map 80 derived from 1D imaging inversions for the synthetic formation always using data from only one receiver and a brute force method to estimate λ in the inversion algorithm, FIG. 5 is a reservoir map 82 derived from 1D imaging inversions for the synthetic formation using only data from two receivers and a learned model to estimate λ in the inversion algorithm, and FIG. 6 is a reservoir map 84 derived from 1D imaging inversions for the synthetic formation always using data from two receivers and a brute force method to estimate λ in the inversion algorithm. In particular, FIG. 3 (one receiver only) and FIG. 5 (two receivers) show the reservoir maps 78, 82 from 1D inversions on a particular formation using the learned model to estimate λ after the first iteration. The reservoir maps 78, 82 of FIGS. 3 and 5 may be compared to reservoir maps 80, 84 of FIG. 4 and FIG. 6, respectively, which are generated from 1D inversions that always use the brute-force method to estimate 1. As illustrated, only a few differences can be identified for the one receiver inversion, and the inversion results for two receivers are almost identical.

### (2) Machine Learning to Replace the Forward Modeling

### Replacement of 1D Forward Modeling

A neural network (NN) that is trained to learn the forward modeling needs to predict the tool responses accurately, especially if deterministic inversion is used. For deterministic inversion, the first derivatives of the responses with respect to the model x are extracted from the NN as well. Small errors in the estimated derivatives may be amplified when the model update Δx is calculated, leading to a significantly distorted model update. This can cause an early termination of the inversion, increasing the likelihood of missing the global minimum solution.

In addition, such a NN may only be trained for a specific scenario: In 1D, the number of layers has to be set beforehand, together with the number of layer boundaries above and below the tool. For example, if it is desired to cover all possibilities for forward modeling three layers around the tool, three separate NNs are needed: one with two boundaries above, one with two boundaries below, and one with a boundary above and below the tool.

It is important to select a meaningful and generally valid set of sample formations to arrive at an accurate NN. Because of the relatively high dimensionality of the problem, formations samples should honor the tool sensitivity, and have to be generated in a smart and efficient way. For example, in the 1D case, five layers already lead to 15 unknowns: five for Rh (i.e., horizontal resistivity), five for Rv/Rh (i.e., vertical resistivity over horizontal resistivity), four for the boundary position, and one for dip.

The following parameter ranges may be chosen:

$$Rh = 10 \hat{} x with x ∈ [ \begin{matrix}- 1 & 3\end{matrix} ]$$

$$Rv / Rh = e \hat{} x with x ∈ [ \begin{matrix}0 & 3\end{matrix} ]$$

Distance to the first boundary and consecutive bed thicknesses between 0.2 m and 2*N/spacing (number of layers N)
Relative dip ∈[−15 15]

For proof of concept, five layers (e.g., with two boundaries above the tool and two boundaries below the tool) were chosen for a deep directional resistivity tool with one receiver (transmitter-receiver spacing 12.7 meters). The training set was generated using uniform random sampling within the formation parameter ranges. 10 million random formations were generated and forward modeled. A fully connected deep NN with four hidden layers of 400 neurons each (e.g., all including a bias term and using the rectified linear unit, or “ReLU”, activation function) was trained to predict the measurement responses of 24 deep directional resistivity measurements (e.g., normalized to [−1,1]) as a function of the 15 formation parameters (e.g., normalized to [0,1]). Split into 90% training and 10% test data, the NN achieved a mean squared error of less than 2*10⁻⁴ on the test data after 200 training epochs.

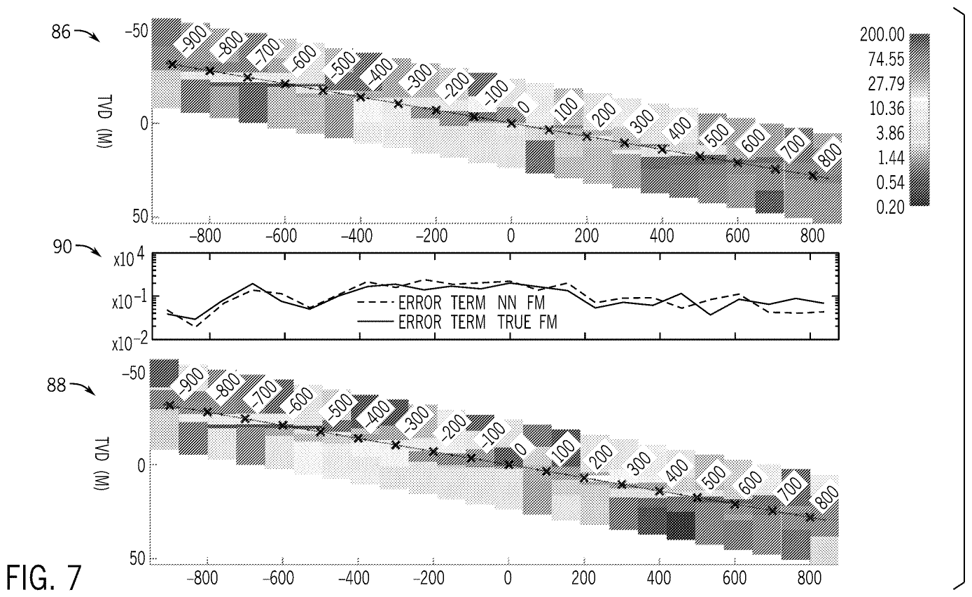

The NN was then used for the inversion of simulated deep directional resistivity tool data where the tool crosses through the formation at an 88° inclination. The tool responses were generated using the true forward modeling and perturbed with realistic white Gaussian noise. The inversion used 20 random initial guesses for each MD (i.e., measure depth) point and always inverts for the two boundaries above and below the tool as the NN was trained for. The inversions were carried out at 24 points along the trajectory, covering the complete formation profile. FIG. 7 illustrates the resulting 2D reservoir map 86 (e.g., displaying the solution with the smallest error term) and compares it to the reservoir map 88 that can be achieved if the true forward modeling is used in the inversion (otherwise same inversion setup). The inversion with the NN replacing the forward modeling performs well, with its resulting reservoir map being very similar to the reservoir found with the true forward modeling. The best (minimum error term) solutions 90 of 20 initial guesses plotted and the achieved error term compared. The comparison of the error terms that were found confirm this; on average, the inversion with the NN can reconstruct the measurements as well as the inversion with the true forward modeling. In other words, the NN is accurate enough to be used in the inversion.

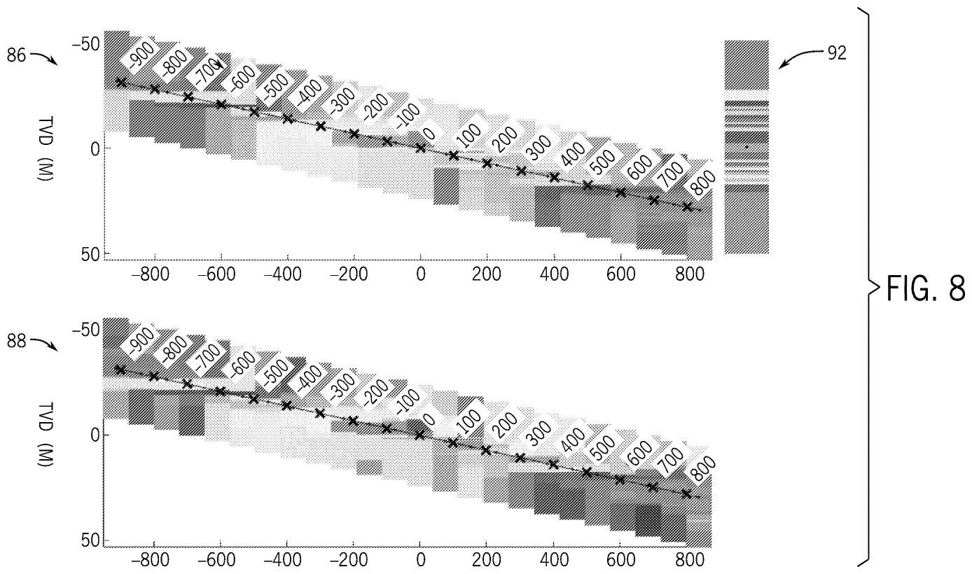

Usually, only the averaged solution of all initial guesses is used for display. The averaged solutions of the 1D inversion results of FIG. 7 may be compared in FIG. 8, which includes reservoir maps 86, 88 derived from the same 1D imaging inversions as FIG. 7, but showing the averaged solution instead of the best solution, where the found resistivity profile is compared to the true resistivity profile 92 on the top right side (i.e., same color map as FIG. 7). Again, the two solutions are very similar. Furthermore, FIG. 8 compares the found reservoir maps to the true formation profile 92 (shown on the top right), confirming the inversion using the NN can consistently find the global minimum solution.

### 3) Machine Learning to Replace the Inversion Algorithm

### Full Replacement of 1D Inversion

Similar to the replacement of the forward modeling, it is important to select a meaningful and generally valid set of sample formations to train a neural network that aims to replace the complete inversion process. Because of the high dimensionality of the problem, random formations honoring tool sensitivity have been generated with the following setup:
Rh=10\hat{ }x with x∈[−1 3], uniformly distributed
Rv/Rh=e\hat{ }x with x∈[0 3], uniformly distributed
Boundary position randomly selected with probability distribution following tool sensitivity
Relative dip ∈[−30 30], uniformly distributed
Minimum Rh contrast between layers enforced
Tool response perturbed with realistic noise (which makes NN robust to noise)

A neural network may be trained to learn both model-based inversion (e.g., inverting for the boundary position in addition to Rh and Rv/Rh) and pixel-based inversion (e.g., only inverting for the layer Rh and Rv/Rh). As for regular inversion, the pixel approach exhibits less non-linearity, is better behaved, and leads to better inversion results. Usually, 39 pixels (for one receiver) or 46 pixels (for two receivers) are used in the inversion.

In total, one million sample formations representing one layer up to four (for one receiver) or five (for two receivers) layers have been generated and forward modeled. The NN inputs are the 24 (one receiver) or 48 (two receivers) deep directional resistivity measurements.

Using a fully connected deep NN with three hidden layers of 200 neurons each (e.g., including a bias term and ReLU activation function), the mapping from tool measurements to resistivity profile may be successfully learned. Three NNs are trained to estimate the full profile, one for Rh, one for Rv/Rh, and one for the dip.

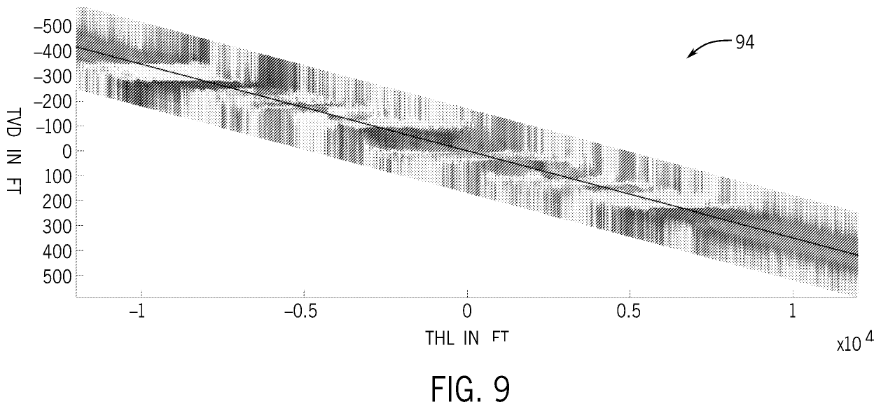

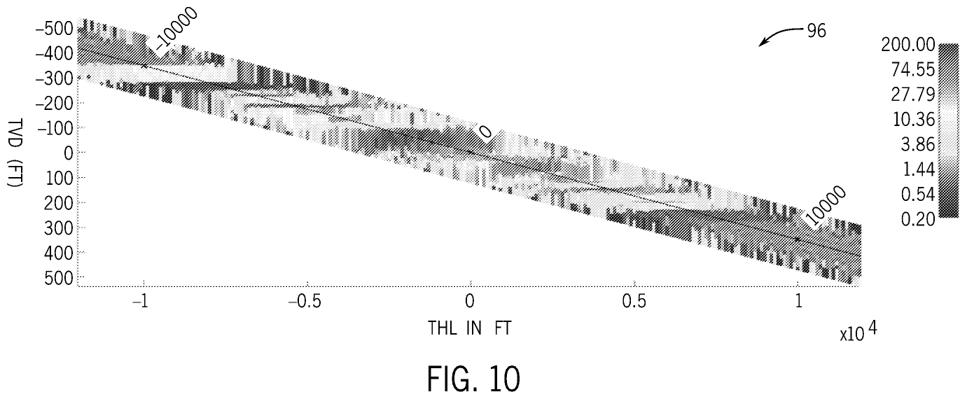

The trained NN is used to invert the simulated tool responses of a two receiver deep directional resistivity tool (e.g., transmitter-receiver spacings 12.7 m and 25.3 m) traversing a formation (e.g., layer thicknesses increased by a factor of four) at 88° inclination. The simulated tool responses are perturbed with noise to provide a realistic scenario. FIG. 9 is a reservoir map 94 generated with the trained NN on a formation traversed by a deep directional resistivity tool with two receivers, and FIG. 10 is a reservoir map 96 derived from regular 1D imaging inversion on the formation traversed by a deep directional resistivity tool with two receivers. The NN estimated reservoir map 94 of FIG. 9 may be compared to the regular imaging inversion results 96 of FIG. 10. The NN may provide a clean resistivity profile with little artifacts. Only in sections where the deep directional resistivity tool is sensitive to more than five layers, the regular imaging inversion outperforms the NN because the NN was only trained with a maximum of five layers.

### Replacement of Workflow Step 2D Inversion

2D azimuthal inversion reconstructs the resistivity distribution in a plane that may be arbitrarily aligned with respect to the tool. The alignment of the inversion plane may be described by two angles, which are inverted as well. The embodiments described herein utilize a multistep workflow, first using only data from the short receiver and then data from both receivers. Each inversion step uses multiple initial guesses with varying alignment angles. NNs are used to replace the intermediate inversion step with only one receiver. Again, formation samples are generated and forward modeled in 2D. The following 2D scenario is considered:
3-layer formation with different Rh and Rv/Rh per layer
   Minimum Rh contrast and minimum center layer height enforced.
   Tilt to the side ∈[−25° 25°]
One fault to the side:
   Position uniformly distributed
   angle ∈[−30° 30°] from vertical
3-layer formation on other side of fault
   Same Rh order and values
   Newly selected boundary positions and tilt
   Random constant shift of boundary positions.

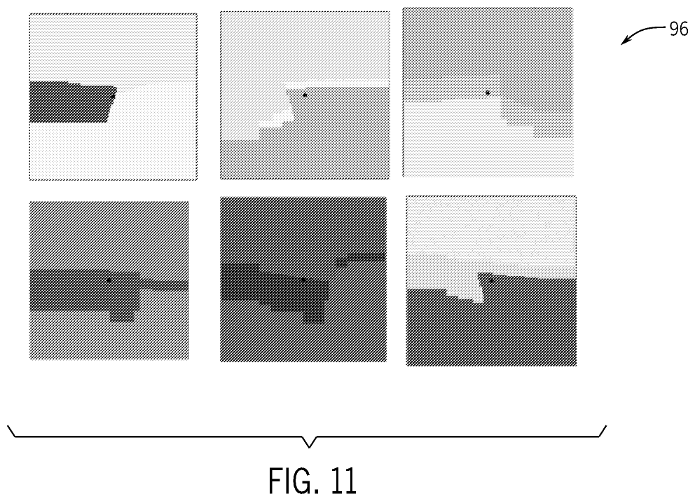

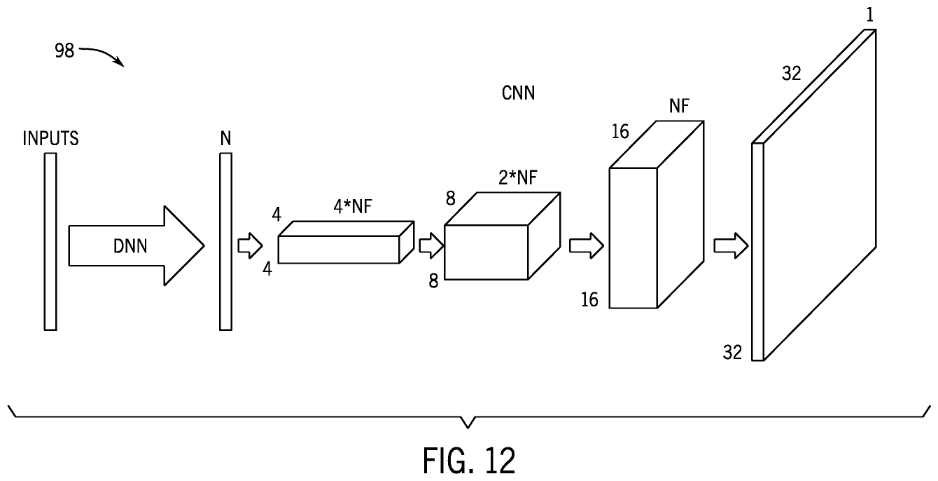

The alignment angles of the 2D plane are sampled uniformly. The formation samples are pixelized on a non-uniform 32×32 grid. Six pixelized random sample formations that follow the aforementioned rules are plotted in FIG. 11. FIG. 12 illustrates a NN architecture for the 2D inversion of one receiver data. 300k samples are generated following the Latin Hypercube Sampling scheme, and a NN is trained that is a combination of a 1D deep NN (DNN) and a convolutional NN (CNN). The inputs are the deep directional resistivity channels and the outputs are the 32×32 pixels for Rh or Rv/Rh. Use of a convolutional NN allows accurate reconstruction of the blocky reservoir features seen in FIG. 11. The size of feature maps Nf and the latent space vector size N are optimized with an emphasis on reducing overfitting artifacts on real data.

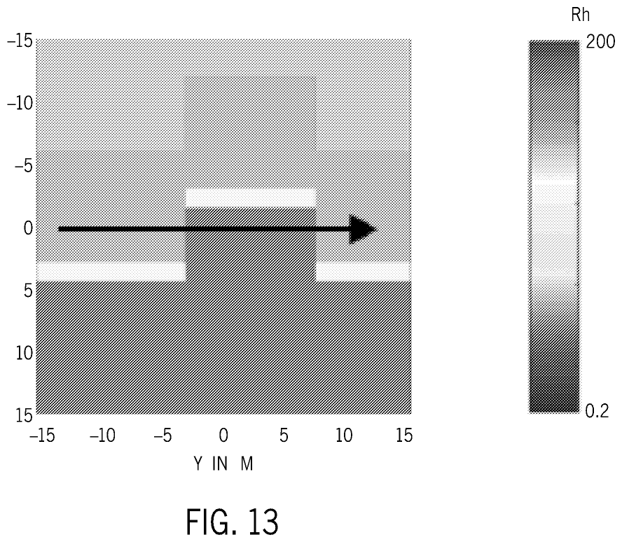

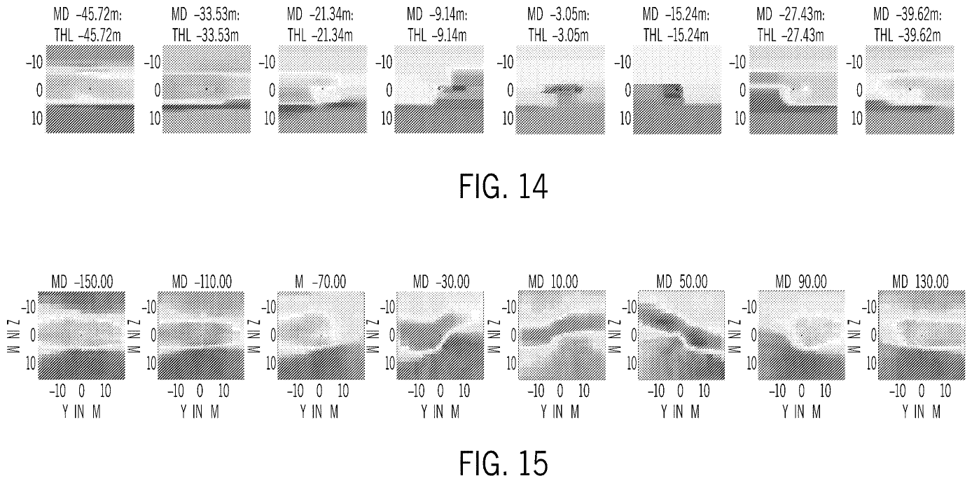

The trained NN is tested on the synthetic formation of FIG. 13, which illustrates a sample formation for deep directional resistivity measurement generation. Deep directional resistivity measurements are generated for a horst structure traversed at a relative azimuth angle of 25° and perturbed with realistic noise. For comparison, FIG. 14 illustrates the standard inversion result of a deep directional resistivity tool with one receiver traversing the formation of FIG. 13 from the left to the right. In particular, FIG. 14 illustrates the inversion result using the standard minimization algorithm for eight points along the well path, clearly imaging the horst structure approaching from the right and crossing through it.

FIG. 15 illustrates the corresponding estimated resistivity distribution using the trained deep and convolutional NNs of FIG. 12. For all eight stations, the NN reconstructs the reservoir structure around the wellbore well. The NN estimation of FIG. 15 may be used as the starting point for the final standard inversion with two receivers. The increased depth of investigation leads to a good estimation of the horst structure around the wellbore.

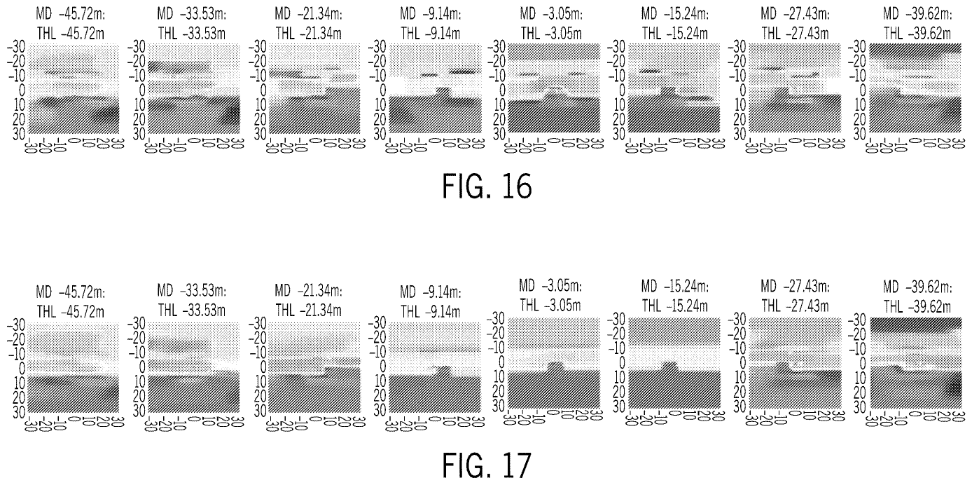

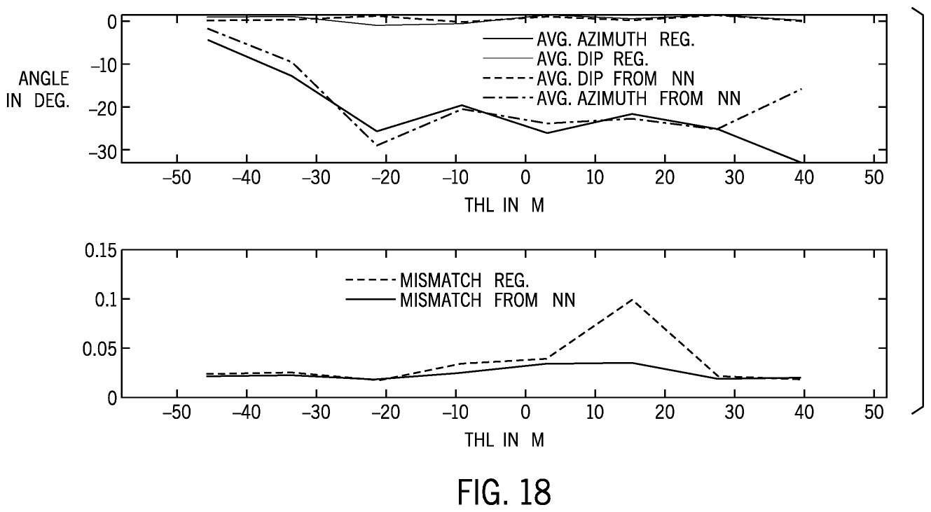

FIG. 16 illustrates an inversion result of a deep directional resistivity tool with two receivers traversing the formation of FIG. 13 from the left to the right, using the NN inversion results of FIG. 15 as an initial guess. This inversion result may be compared to an inversion that is started with the standard inversion result of FIG. 14, as shown in FIG. 17. The final two receiver inversion started with the NN is as good or even better than the final two receiver inversion that uses no NN. This is confirmed by FIG. 18, the inversion mismatch for NN started inversion is either equal or lower than the mismatch of the inversion without NN. The final inverted alignment angles (e.g., azimuth and dip) of the 2D plane are comparable.

The embodiments described herein replace portions of a complete inversion algorithm for deep directional resistivity data with machine learning. As described in greater detail herein, such utilization of machine learning may take various forms. For example, in certain embodiments, regularization parameter estimation may be replaced with machine learning. Such embodiments include gradient boost regression trees that are used to generate inversion results with correctly estimated regularization parameter (e.g., through Occam search), which are used for training a machine learning model using statistics of the inverted model and inversion as input variables for the machine learning model. In other embodiments, forward modelling of an inversion workflow may be replaced by machine learning. Such embodiments are relatively well suited for model-based inversions, and generally include a training set consisting of smartly sampled formation realizations (e.g., random, Latin Hypercube, or sparse grid) that honor measurement sensitivity. In general, such embodiments require a relatively high number of samples for accurate NN predictions using wide and deep DNN. In other embodiments, the inversion itself may be replaced by machine learning, either of one workflow step or the complete workflow. Such embodiments are relatively well suited for imaging inversions, and generally include a training set consisting of smartly sampled formation realizations (e.g., random, Latin Hypercube, or sparse grid) that honor measurement sensitivity, and which may be pixelated or voxelated for imaging inversions. In general, such embodiments may utilize a DNN for 1D inversions and may utilize DNN+CNN for 2D or 3D inversions. As such, as described in greater detail herein machine learning may be applies to both imaging and model-based inversions.

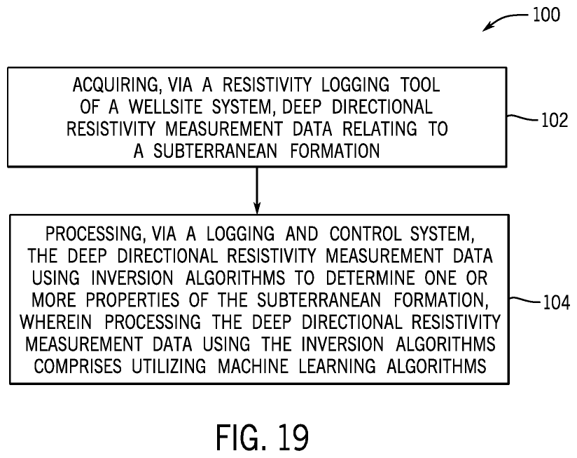

FIG. 19 is a flow diagram of a method 100 of utilizing machine learning algorithms as part of inversion algorithms used to process deep directional resistivity measurement data, as described in greater detail herein. As illustrated, in certain embodiments, the method 100 may include acquiring, via a resistivity logging tool of a wellsite system 10, deep directional resistivity measurement data relating to a subterranean formation 14 (block 102). In addition, in certain embodiments, the method 100 may include processing, via a logging and control system 56, the deep directional resistivity measurement data using inversion algorithms to determine one or more properties of the subterranean formation 14, wherein processing the deep directional resistivity measurement data using the inversion algorithms includes utilizing machine learning algorithms (block 104). In addition, in certain embodiments, the method 100 may include automatically adjusting operational parameters of the resistivity logging tool of the wellsite system 10 based at least in part on the determined one or more properties of the subterranean formation 14 in substantially real time during operations of the resistivity logging tool of the wellsite system 10.

In addition, in certain embodiments, utilizing the machine learning algorithms includes replacing regularization parameter estimations of the inversion algorithms with the machine learning algorithms. In such embodiments, replacing the regularization parameter estimations of the inversion algorithms includes utilizing gradient boost regression trees. In addition, in such embodiments, replacing the regularization parameter estimations of the inversion algorithms includes training a machine learning model with inversion results having estimated regularization parameters to create an inverted model. In addition, in such embodiments, replacing the regularization parameter estimations of the inversion algorithms includes using statistics of the inverted model and the inversion results as input variables for the machine learning model.

In addition, in certain embodiments, utilizing the machine learning algorithms includes replacing forward modeling of the inversion algorithms with the machine learning algorithms. In such embodiments, replacing the forward modeling of the inversion algorithms with the machine learning algorithms includes using a training set that includes formation realizations. In addition, in such embodiments, replacing the forward modeling of the inversion algorithms with the machine learning algorithms includes using a deep neural network.

In addition, in certain embodiments, utilizing the machine learning algorithms includes directly replacing at least a portion of the inversion algorithms with the machine learning algorithms. In such embodiments, directly replacing the at least a portion of the inversion algorithms with the machine learning algorithms includes using a training set that includes formation realizations. In addition, in such embodiments, directly replacing the at least a portion of the inversion algorithms with the machine learning algorithms includes pixelating or voxelating the formation realizations for imaging inversions. In addition, in such embodiments, directly replacing the at least a portion of the inversion algorithms with the machine learning algorithms includes using a DNN for 1D inversions. In addition, in such embodiments, directly replacing the at least a portion of the inversion algorithms with the machine learning algorithms includes using a combination of a DNN and a CNN for 2D inversions or 3D inversions.

In addition, in certain embodiments, the method 100 may include applying the machine learning algorithms to imaging-based inversions or model-based inversions. In addition, in certain embodiments, the method 100 may include controlling one or more operational parameters of equipment of the wellsite system based at least in part on the determined one or more properties of the subterranean formation 14.

While embodiments have been described herein, those skilled in the art, having benefit of this disclosure, will appreciate that other embodiments are envisioned that do not depart from the inventive scope. Accordingly, the scope of the present claims or any subsequent claims shall not be unduly limited by the description of the embodiments described herein.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform] ing [a function] . . . ”, it is intended that such elements are to be interpreted under 35 U.S.C. § 112(f). However, for any claims containing elements designated in any other manner, it is intended that such elements are not to be interpreted under 35 U.S.C. § 112(f).

What is claimed is:

1. A method, comprising:
acquiring, via a resistivity logging tool of a wellsite system, deep directional resistivity measurement data relating to a subterranean formation; and
processing, via a logging and control system, the deep directional resistivity measurement data using inversion algorithms to determine one or more properties of the subterranean formation, wherein processing the deep directional resistivity measurement data using the inversion algorithms comprises utilizing machine learning algorithms.

2. The method of claim 1, wherein utilizing the machine learning algorithms comprises replacing regularization parameter estimations of the inversion algorithms with the machine learning algorithms.

3. The method of claim 2, wherein replacing the regularization parameter estimations of the inversion algorithms comprises utilizing gradient boost regression trees.

4. The method of claim 3, wherein replacing the regularization parameter estimations of the inversion algorithms comprises training a machine learning model with inversion results having estimated regularization parameters to create an inverted model.

5. The method of claim 4, wherein replacing the regularization parameter estimations of the inversion algorithms comprises using statistics of the inverted model and the inversion results as input variables for the machine learning model.

6. The method of claim 1, wherein utilizing the machine learning algorithms comprises replacing forward modeling of the inversion algorithms with the machine learning algorithms.

7. The method of claim 6, wherein replacing the forward modeling of the inversion algorithms with the machine learning algorithms comprises using a training set that includes formation realizations.

8. The method of claim 6, wherein replacing the forward modeling of the inversion algorithms with the machine learning algorithms comprises using a deep neural network.

9. The method of claim 1, wherein utilizing the machine learning algorithms comprises directly replacing at least a portion of the inversion algorithms with the machine learning algorithms.

10. The method of claim 9, wherein directly replacing the at least a portion of the inversion algorithms with the machine learning algorithms comprises using a training set that includes formation realizations.

11. The method of claim 10, wherein directly replacing the at least a portion of the inversion algorithms with the machine learning algorithms comprises pixelating or voxelating the formation realizations for imaging inversions.

12. The method of claim 9, wherein directly replacing the at least a portion of the inversion algorithms with the machine learning algorithms comprises using a deep neural network for one-dimensional inversions.

13. The method of claim 9, wherein directly replacing the at least a portion of the inversion algorithms with the machine learning algorithms comprises using a combination of a deep neural network and a convolutional neural network for two-dimensional inversions or three-dimensional inversions.

14. The method of claim 1, comprising applying the machine learning algorithms to imaging-based inversions or model-based inversions.

15. The method of claim 1, comprising controlling one or more operational parameters of equipment of the wellsite system based at least in part on the determined one or more properties of the subterranean formation.

16. A logging and control system configured to:
receive deep directional resistivity measurement data relating to a subterranean formation that is acquired by a resistivity logging tool of a wellsite system; and
process the deep directional resistivity measurement data using inversion algorithms to determine one or more properties of the subterranean formation, wherein processing the deep directional resistivity measurement data using the inversion algorithms comprises utilizing machine learning algorithms

17. The logging and control system of claim 16, wherein utilizing the machine learning algorithms comprises replacing regularization parameter estimations of the inversion algorithms with the machine learning algorithms.

18. The logging and control system of claim 16, wherein utilizing the machine learning algorithms comprises replacing forward modeling of the inversion algorithms with the machine learning algorithms.

19. The logging and control system of claim 16, wherein utilizing the machine learning algorithms comprises directly replacing at least a portion of the inversion algorithms with the machine learning algorithms.

20. The logging and control system of claim 16, wherein the logging and control system is configured to control one or more operational parameters of equipment of the wellsite system based at least in part on the determined one or more properties of the subterranean formation.
